(19) United States
(12) Patent Application Publication
(10) Pub. No.: US 2007/0116229 A1
(43) Pub. Date: May 24, 2007

(54) Method for forwarding a call to a call number that is assigned to the originally dialed number by means of a directory system

(76) Inventor: Thomas Lederer, Herrsching (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/563,490

(22) PCT Filed: Jun. 7, 2004
(86) PCT No.: PCT/EP04/51049

§ 371 Date: Jan. 3, 2006

(30) Foreign Application Priority Data
Jul. 3, 2003 (DE) 10330074.0

(51) Int. Cl. H04M 3/42

(52) U.S. Cl. 379/211.02

(57) ABSTRACT

A method for forwarding a call, in which a first number, which is entered on a first telecommunications terminal and is assigned to a second terminal, is used to establish a connection to the second terminal and the call remains unanswered in the second terminal is provided. The method allows the A-subscriber to reach a person by telephone who is assigned to the B-subscriber by triggering the transmission of a message from the first terminal to the automatic telecommunications service to determine an alternative number. The service then determines a second number of a third terminal, using an electronically stored assignment regulation from a directory, and the second number is used to establish a connection between the first and the third terminals.

### CROSS REFERENCE TO RELATED APPLICATIONS

This application is the US National Stage of International Application No. PCT/EP2004/051049, filed Jun. 7, 2004 and claims the benefit thereof. The International Application claims the benefits of German application No. 10330074.0 DE filed Jul. 3, 2003, both of the applications are incorporated by reference herein in their entirety.

### FIELD OF INVENTION

The invention relates to a method for call forwarding and to an arrangement for implementing the method.

### BACKGROUND OF INVENTION

Automatic forwarding or redirection, in which an incoming call to a telecommunication terminal is redirected directly to another terminal or to a call answering service of the called party, is a known method for call forwarding. Instead of the automatic or unconditional call forwarding, it is also possible to set up conditional call forwarding which forwards an incoming call depending on whether the called terminal is busy, i.e. a call is already in progress at said terminal, or the incoming call has not yet been answered after a specified time period. Particularly in the field of mobile telephony, there also exists the possibility of so-called call redirection or rerouting if the mobile subscriber is not available, i.e. if the mobile telephony terminal of the mobile subscriber has not been switched on or is not available for some other reason.

These known call rerouting or call forwarding facilities are implemented as telecommunication services or as product features associated with a product profile of a global service (e.g. associated with the ISDN telephone service). Such a service establishes a specific type of telecommunication between two terminals, which is implemented automatically, i.e. without human intervention.

Such a service is implemented by providing correspondingly configured entities in the exchanges of a telecommunication network and/or in the terminals. In order to make the service available to an individual user, the entities must be configured or set up for this. In this case, the conventional call rerouting is set up by the called subscriber, who is frequently referred to as the “B subscriber”. This is laborious for said subscriber if he or she is only leaving the workplace for a brief period, for example. In addition, the setting up of a redirection is often forgotten, e.g. before starting a vacation. Furthermore, once it has been set up, a redirection does not take into consideration the different possible requests of the caller or the “A subscriber”. Moreover, the latter is frequently poorly served by being forwarded to the call answering service, e.g. in the case of pressing inquiries.

In order the resolve an issue, the A subscriber often wishes to contact a further person, the “C subscriber”, at short notice instead of the absent B subscriber, said C subscriber being a colleague or deputy of the B subscriber, the manager of the B subscriber, a secretarial service which is assigned to the B subscriber, etc. In order to achieve this, the A subscriber must ring off, find out the telephone number of the desired person and then dial again.

This telephone number could also be an additional number of the B subscriber, e.g. his or her mobile phone number if B is on a business trip.

Finding out this second call number often involves some effort. A must look in directories, directory lists, organization charts or other directory systems.

Provision is often made for electronic directory systems (employee directories) in which the user has to search using his or her PC. Directory systems (e.g. as per the X.500 or LDAP standard) make it possible to access directories and their entries, i.e. to search and read them. Each entry consists of a plurality of attributes, e.g. employee name, call number, department, office number, in which specific attribute values are entered for each employee. Directories may be distributed over a plurality of software/hardware entities, particularly if e.g. a member directory of a large company contains in the order of 100,000 entries, wherein the employees are distributed over a plurality of locations.

Queries are performed by user agents and directory system agents (or the units which implement this functionality). Such queries can turn out to be complex, if e.g. the user agent only has access to an electronically stored assignment specification which allows the identification of those employees of the B subscriber who have the same departmental designation. It is then necessary in a second step to identify those colleagues who are situated in the same office by means of a manual inspection.

However, it is resource-intensive to enter and manually process such queries on the PC every time. Even if the effort only takes a few minutes, it is often no longer beneficial in relation to the content of the inquiry which was originally the purpose of the call to the B subscriber.

### SUMMARY OF INVENTION

There is therefore a need to propose a method for call forwarding, which method allows the A subscriber in a simple and convenient manner to make telephone contact with a person who is assigned to the B subscriber if the B subscriber does not accept a call, said need being the origin of the problem which is addressed by the present invention. The invention also addresses the problem of proposing an arrangement with which such a method can be implemented.

This object is achieved by a method and an arrangement as claimed the independent claims. An essential idea of the invention consists in providing a telecommunication service that allows a further call number which is assigned to the B subscriber to be made available to the A subscriber e.g. by using electronic directories that already exist. A further essential aspect of the invention consists in the telecommunication service being activated by the terminal of the A subscriber. Consequently, the setting up of call redirections at the terminal of the B subscriber becomes superfluous or is at least simplified. In configurations of the invention, the A subscriber can personally decide whether, and if applicable to whom, a forwarding is desired.

Specifically, a method for call forwarding is proposed which takes as its starting point the situation that a first call number, which is entered at a first telecommunication terminal and is allocated to a second terminal, is used in order to establish a connection to the second terminal and the call is not accepted at the second terminal. According to the invention, the first terminal triggers the transfer of an identification inquiry message containing the first call number to an automatic telecommunication service in order to identify an alternative call number. The telecommunication service thereupon identifies a second call number of a third terminal by means of an electronically stored assignment specification from an electronic directory system containing the first call number and a multiplicity of call numbers which are allocated to further terminals. The second call number is then used to establish a connection between the first terminal and the third terminal.

In an embodiment of this method, the transfer of the identification inquiry message is triggered in response to a first input of a user at the first terminal.

In a development of the claimed method, attributes with attribute values are assigned to each call number in the directory system. The assignment specification can then refer to an attribute for the first call number, wherein said attribute contains the second call number, or it can refer to an attribute whose value is identical for the first and second call numbers, or even a combination of both.

It is thus possible, in addition to a second call number which is directly and explicitly assigned to the originally dialed first telephone number, to identify further telephone numbers which are allocated e.g. to terminals belonging to colleagues who have the same departmental designation, the same room number or the same attributes. It is likewise possible thus to identify a second business telephone number, a private number or a mobile telephone number of the B subscriber. If a combination of both assignment types is used, it is possible for e.g. an attribute of the first call number to contain the numbers of all departmental colleagues; from these numbers, a supplementary search identifies those which are assigned to terminals that are located in the same room.

In an embodiment of the method according to the invention, the connection setup between the first and third terminals can be initiated automatically after identification of the second call number. In order to achieve this, the first terminal or the exchange via which the terminals are connectable can be configured correspondingly.

As a result of this, the forwarding for the A subscriber becomes particularly convenient, since he or she can initiate the forwarding merely by means of a single input at his or her terminal, e.g. by pressing a key or selecting a menu option “Forward?” or similar.

Alternatively or additionally, the telecommunication service can return identification result information to the first terminal, which identification result information refers to the second call number or to each second call number and possibly to information that is assigned to said number.

It is thus possible to output the identification result information to the A subscriber, e.g. on a display unit of his or her terminal or by means of voice output.

In a development of this method, the user can effect the connection setup to the third terminal by means of a second input if this has not already happened automatically. This development is particularly significant if the identification result information refers to a plurality of second call numbers from which the user chooses.

In this embodiment, the A subscriber does have to perform a further input at his or her terminal, but has the choice of selecting the forwarding from a plurality of possibilities. The first input and the selection or second input of the A subscriber can take place via the first terminal if at least one of the following entities has been configured at said terminal:
one or more predefined keys,
a display unit with assigned control keys for navigation and selection of a menu option from a menu which is displayed on the display unit,
a voice recognition system for recognizing the first and/or second user input having the form of a voice input.

The voice input can take place via the telephone handset or an additional microphone which is connected to the terminal (“Telephone User Interface”, possibly with DTMF suffix dialing). However, the first or second input can also take place via an input unit which is designed as a keypad on the terminal, e.g. using numeric keys and control keys.

The telecommunication service and/or the directory system can be implemented on a central communication system or an exchange of the telecommunication network via which the terminals can be connected, or implemented in a distributed manner on a plurality of systems or sites. Particularly in the case of large communication networks including many subscribers, this is advantageous with reference to servicing and maintenance of the telecommunication service and the directory. The telecommunication service can be installed on the system(s) or site(s) on which the directory or directories that will be searched are also located or implemented.

Alternatively or additionally, the telecommunication service and/or the directory system can also be implemented on the terminals themselves. In this case, it is conceivable that the subscribers themselves maintain the directories on their terminals, for example, or that these are maintained by means of teleservicing by an administrator.

### BRIEF DESCRIPTION OF THE DRAWINGS

The features and advantages of the claimed arrangement are derived from the features and advantages of the claimed method and of the following exemplary embodiments, which explain the invention in greater detail and are described with reference to the attached drawings, wherein:

FIG. 1 shows an application case of the method according to the invention in the form of a schematized sequence diagram;

FIG. 2 shows a first exemplary embodiment of an arrangement according to the invention in the form of a schematized block diagram;

FIG. 3 shows a second exemplary embodiment of an arrangement according to the invention in the form of a schematized block diagram;

FIGS. 4a) and 4b) show two schematized views of the display of a display unit of a terminal of an arrangement according to the invention.

### DETAILED DESCRIPTION OF INVENTION

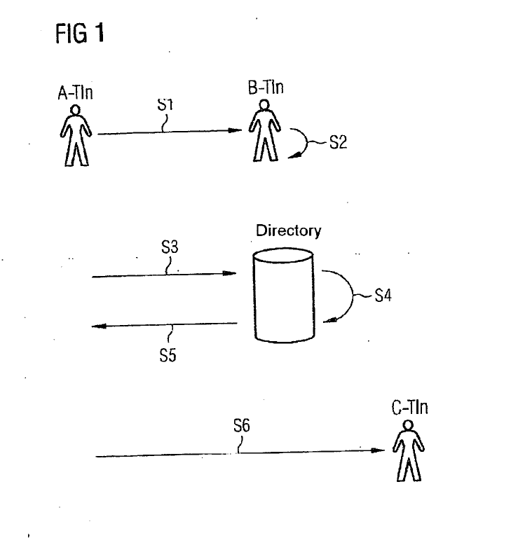

A typical application case of the method according to the invention is now described from a user viewpoint with reference to FIG. 1. The application steps are designated “S1” to “S7”.

In step S1 of the application case, a call which starts from the terminal of the A subscriber (A-Tln) occurs at the terminal of the B subscriber (B-Tln). Since the B subscriber is not present and has not activated any conventional call forwarding, e.g. to a call answering service, the call is not accepted. This state, during which the A subscriber hears a bell, is designated step S2 in the FIG. 1.

A forwarding service according to the invention is set up for the A subscriber. The A subscriber therefore presses a key on his or her terminal, said key having the inscription “Call colleague”, in the third step S3. In response to the key depression the terminal of the A subscriber, which terminal is configured in accordance with the invention, sends a message, specifically an identification inquiry message, to a telecommunication service i.e. more precisely to a central unit by means of which the telecommunication service is implemented. The service identifies call numbers of colleagues of the B subscriber by accessing an organization directory in the application step S4.

In the fifth step S5, the identified call numbers i.e. the forwarding information is transferred to the terminal of the A subscriber and displayed there on a display unit of the terminal. In the sixth step S6, the A subscriber selects a number from the displayed call numbers which are supplemented by additional information for the purposes of the invention, said information comprising e.g. the names and/or the functional designations of the colleagues. The selection can be effected by means of control keys which are configured on the terminal for navigating in the display unit.

The selected call number is then used by the terminal of the A subscriber in the seventh step S7 in order to establish a connection to the terminal of the selected colleague, i.e. the C subscriber (C-Tln).

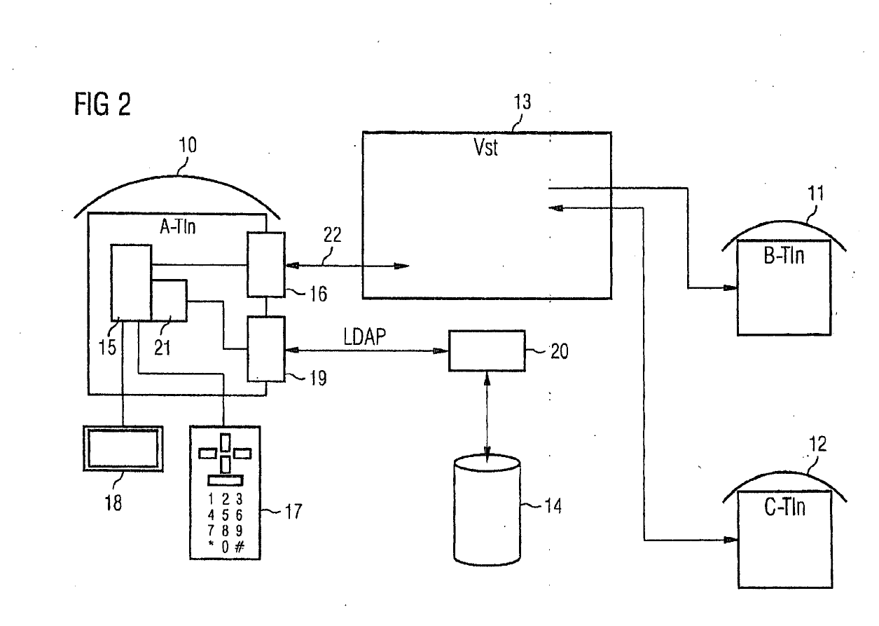

FIG. 2 shows a first exemplary embodiment of an arrangement according to the invention, including a first terminal of the A subscriber 10, a second terminal 11 and third terminal 12 of the B subscriber and C subscriber respectively. The terminals can be interconnected via an exchange 13. A list of the call numbers of all subscribers who are attached to the exchange 13 is present in a directory system 14, e.g. in the form of a database. A series of attributes (“Call number”, etc.) is defined for each entry in the list, wherein one of the attributes (having the designation “Colleagues”) can contain one or more call numbers of colleagues.

If the directory system 14 is an electronic directory system which already exists and in which no “Colleagues” attribute is defined for the entries, it is also conceivable instead to use an existing attribute, e.g. “Department” for automatically identifying colleagues. As a further alternative, it is conceivable that one of the (known or now to be defined) attributes (“Room”) specifies a room number in which the terminal is located and to which a corresponding call number is assigned. In this case, when searching for colleagues of the B subscriber, it would be necessary to identify those call numbers whose “Room” attribute has the same attribute value, i.e. the same room number. If members of different departments share an (open-plan) office, a query of a plurality of attributes with a combination of the results can be effective in some cases, such that e.g. all call numbers are identified whose “Room” attribute has the same attribute value and whose “Department” attribute has the same value (the departmental designation) as the corresponding attribute of the call number of the B subscriber.

The terminal 10 of the A subscriber includes a control entity 15 for controlling the setup and cleardown of connections in accordance with the communication protocols which are used between the terminal 10 and the exchange 13 (e.g. ISDN, QSIG or Voice over IP). For this purpose, the terminal 10 is connected to the telecommunication network via an interface 16. The terminal 10 also includes an input unit 17 and a display or display unit 18. In accordance with the invention, the terminal 10 also includes a user query unit 19 which implements a user agent. This is configured for exchanging messages with a directory system agent which is implemented by a directory system query unit 20. The unit 20 is configured for identifying information from the directory system 14 by means of LDAP (“Lightweight Directory Access Protocol”).

The application case which is described above with reference to FIG. 1 is now discussed in detail with reference to the arrangement that is illustrated in FIG. 2.

Application step S1: In order to reach the B subscriber at the terminal 11, the A subscriber dials the call number of the B subscriber in the usual manner at his or her terminal 10 by entering said number via the input unit 17. The setup of the connection takes place in a known manner as per the telecommunication protocols or standards that are in use. In addition, the call number of the B subscriber, i.e. the call number which is allocated to the terminal 11, is buffered in the terminal 10, specifically in a forwarding control unit 21. Depending on the communication protocols that are being utilized, a voice channel can already be reserved and enabled on the connection branch 22 between terminal 10 and connection point 13, e.g. in the direction of the terminal 10, in order to transfer a dial tone from the exchange 13 to said terminal.

Application step S2: In response to the connection setup request from the terminal 10, a corresponding signal or bell tone rings at the terminal 11 of the B subscriber. However, no bidirectional voice connection between the terminals 10 and 11 is established unless the handset is lifted or the connection setup request is accepted correspondingly. For the subsequent progress of the method according to the invention, the reason why the B subscriber does not accept the call is irrelevant. It is conceivable that the B subscriber is not present or that a call is already being conducted via the terminal 11 and the terminal 11 is therefore busy. It is also possible that the B subscriber has activated an automatic forwarding or rerouting to a call answering service. All of these cases are signaled to the terminal 10 in a suitable way, e.g. by means of a bell tone, a busy tone or the recorded message of the call answering service.

Application step S3: Without first hanging up or explicitly clearing down the connection which is established at least between the terminal 10 and the exchange 13, the A subscriber now presses a “Call colleague” key which is present as part of the input unit 17 at his or her terminal 10. The input is transferred to the control entity 15, which transfers a corresponding command to the forwarding control unit 21. In response to the command, the control unit 21 supplies the buffered call number of the B subscriber to the user query unit 19. This is connected to the directory system query unit 20 via an Internet connection and by means of the LDAP protocol and transfers the call number of the B subscriber to the unit 20 in an identification inquiry message which also contains an attribute designation, specifically the designation of the “Colleagues” attribute, as additional information.

Application step S4: Depending on the structure of the directory or directories in the directory system 14, the directory system query unit 20 now identifies which call numbers of colleagues are assigned to the call number of the B subscriber. For example, the call numbers can be explicitly assigned to each call number in a corresponding “Colleagues” attribute, or the directory system query unit 20 can be configured in such a way as to identify call numbers via the comparison of attribute values. It is conceivable, for example, to identify all call numbers which are assigned to terminals that are located in the same room as the terminal 11 of the B subscriber.

Application step S5: The forwarding information which refers to the identified call numbers and possibly to attribute values which are assigned to said call numbers, e.g. subscriber names and/or functional designations and/or characteristics of the telephone numbers (business/private/mobile/secretarial), are transferred from the directory system query unit 20 to the user query unit 19 by means of the LDAP protocol.

Application step S6: Within the device, the forwarding information is supplied from the user query unit 19 to the forwarding control unit 21. The latter buffers the information and supplies all or part of the forwarding information to sub-units (not shown) of the control entity 15, which is also configured to control the display of this information on the display unit 18. Using control keys which are part of the input unit 17, the A subscriber selects one of the call numbers that are presented to him or her.

Application step S7: The call number which is selected via the input unit 17 is utilized by the control entity 15 in a conventional way to establish a connection to the terminal 12 of a C subscriber to whom the selected call number is assigned. Before this takes place, the connection to the terminal 11 is cleared down if it was already set up. This also applies to the connection branch 22.

The described method allows the A subscriber to select, in a simple manner by means of two inputs at his or her terminal, a forwarding to a subscriber who is sought by said A subscriber and who can be associated with the original B subscriber in one of a plurality of ways that are predetermined by the directory system, and to establish a connection to this C subscriber. This requires no resource-intensive identification of the call number by the A subscriber whatsoever. It is conceivable that the identification results of the directory system agent are dependent on further parameters such as, for example, the time of day or the presence or absence of individual people. It is thus possible to ensure that suitable contacts are proposed to the A subscriber at all times.

Both the connection 22 and the LDAP connection between the user agent and the directory system agent can run via a single connection interface of the terminal 10 if this terminal is a suitable device for Internet telephony. Alternatively, the transfer of messages between the agents can also take place in accordance with the X.500 standard. The corresponding communication between the agents can then also run via an ISDN connection. If the connection 22 is such a connection, only one conventional ISDN connection interface is then required for connecting the terminal 10 which is configured as an ISDN device in this case.

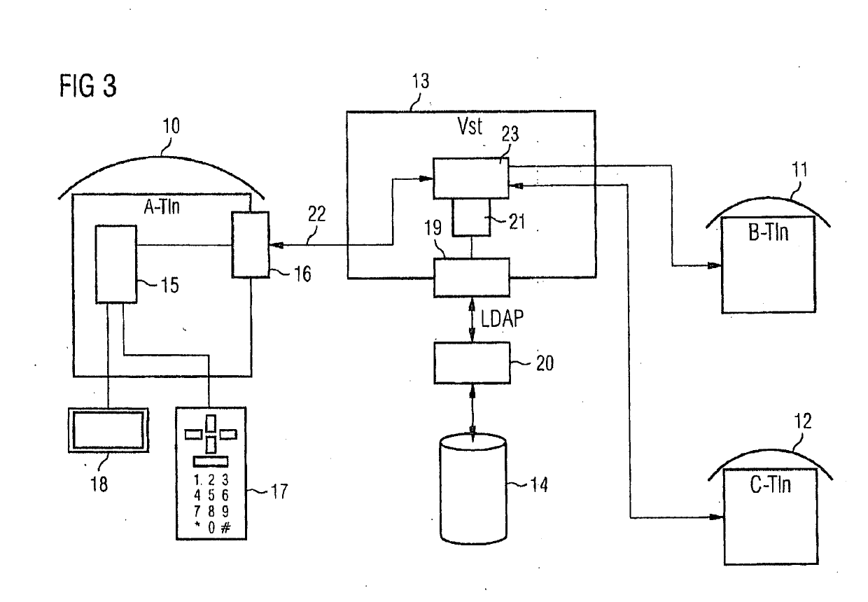

A second exemplary embodiment of an arrangement according to the invention is shown in FIG. 3. Identical elements having identical effect are designated using identical reference numerals in the figures.

In the first exemplary embodiment, a forwarding control unit 21 is configured in the terminal 10. In the present exemplary embodiment, the forwarding control unit 21 is configured in the exchange 13 as shown in FIG. 3. Accordingly, a user query unit 19 is not located in the terminal 10 but in the exchange 13.

Consequently, in comparison with the method which is described with reference to FIG. 2, there is a difference in the application step S3 (see FIG. 1). When pressed by the A subscriber, the “Call colleague” key which is part of the input unit 17 causes a corresponding command to be transferred from the control entity 15 of the terminal 10 to the forwarding control unit 21 as before. However, the latter is no longer located internally within the terminal 10. In order to transfer a command, a control command can be transferred from the terminal 10 to the switching station 13, however, e.g. via the signaling connections which exist in relation to the setting up of the connection 22. The control command is supplied to the forwarding control unit 21 by the control entity 23 of the switching station.

The call number of the B subscriber is already present in the switching station 13, since this number has already been used for setting up the connection to the terminal 11. The identification of the call number which has been assigned to the B subscriber therefore takes place as described in the first exemplary embodiment.

In FIG. 3, according to the second exemplary embodiment, the application step S5 provides for supplying the identified forwarding information from the forwarding control unit 21 to the control unit 23, which transfers said information to the terminal 10 or its control entity 15 via the existing signaling connections. The forwarding information can then be displayed at the display unit 18 as described above.

In the step S6, the call number which is selected by the A subscriber is transferred from the terminal 10 to the switching station 13, i.e. to its control entity 23. In order to establish a connection to the C subscriber, or to the terminal 12 of said subscriber, it is not necessary to clear down the connection branch 22 which was established when setting up the connection to the terminal 11. Instead, this connection branch 22 can be used for the connection to the C subscriber, thereby shortening the setup times in comparison with the first exemplary embodiment. At the same time, the connection branch from the switching station 13 to the terminal 11 is cleared down.

This second exemplary embodiment offers the advantage that, in order to carry out the method according to the invention, the terminal 10 needs to be modified only slightly or even not at all, i.e. commercially available terminals can be used. The control command which is generated by the “Call colleague” key that is used (in the described examples) can be implemented by programming the key to provide a control code, for example, said control code being transferred to the switching station in a conventional manner by means of signaling. The control code is interpreted in the switching station 13 by means of its control entity 23 in a manner according to the invention. The central telecommunication service would therefore only require modifications or implementations at existing switching stations.

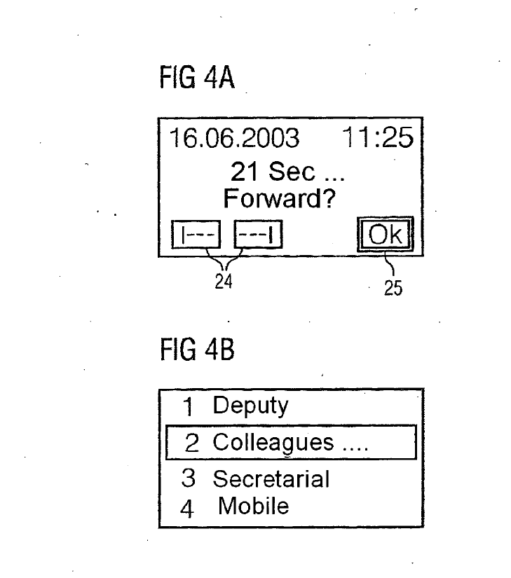

The FIGS. 4a) and 4b) show in each case a display of a display unit of a terminal of an arrangement according to the invention. For example, the display in the FIG. 4a) can be presented to the A subscriber during the application step S2 which is described above. The elapsed time since the first bell tone at the terminal of the B subscriber can be shown to the A subscriber, and the possibility of forwarding in accordance with the invention can be offered to said A subscriber. Various icons 24, 25 are shown in the display and their selection causes further information to be displayed on the display unit. The icons can be selected using known control keys of the input unit 17 which is shown in FIGS. 2 and 3. The selection or activation of the icon 25 (“Ok”) corresponds to the “Call colleague” key which is mentioned in the first two exemplary embodiments. Selection of the icon 25 results in the transfer of an identification inquiry message from the terminal 10 to the directory system query unit (20) in the manner which is described above.

In response to the forwarding information which is identified by the directory system query unit, the A subscriber is presented with a new display on the display unit, e.g. as illustrated in FIG. 4b). This display represents a continuation of the method which is described in the first two exemplary embodiments, in as much as it is not just possible to reach one or more colleagues of the B subscriber, but the A subscriber can also select whether he or she wishes to contact a deputy, the secretarial service which is assigned to the B subscriber, or the mobile telephony terminal of the B subscriber. Many other options of this type are conceivable, and these could be presented by means of additional entries on the display unit.

The A subscriber can immediately initiate a connection setup to the designated office, for instance the secretarial service, by selecting a line. Alternatively, by selecting the line “Colleagues . . . ” which is indicated in FIG. 4b), said subscriber can obtain a sub-menu which then lists a plurality of colleagues of the B subscriber, said colleagues being either located in the same office environment and/or belonging to the same department. It is also conceivable for the A subscriber to select one of the entries in FIG. 4b) by speaking a voice command into the handset or a microphone of his or her terminal, e.g. saying the words “Select 3” or “Connect to 3” (in order to call the secretarial service immediately). Since the A subscriber is already holding the telephone handset in his or her hand, or is near to an input microphone which is connected to the terminal, this input of a voice command is particularly convenient for the A subscriber. The terminal must have a speech recognition system for this purpose.

It is obvious to a person skilled in the art that many other possibilities are conceivable for the selection of forwarding options. For example, it is even possible to make a selection using telephones without a display unit, if e.g. a combination of * key, # key and numbers is predefined as a selection command. For example, the sequence ‘*41’ could represent the “Call colleague” command and ‘*42’ could represent “Call manager”, etc. If a selected option is not available the terminal would output an error tone, e.g. if a mobile telephony number of the B subscriber is selected using ‘*43’ but is unavailable.

It is likewise conceivable, by configuring his or her terminal once, for the A subscriber to ensure that the service according to the invention automatically identifies the call number(s) assigned to the B subscriber, e.g. after five rings.

It is possible to conceive of a multiplicity of further modifications of the embodiments which are described here by way of example in relation to the invention. For example, only one exchange is drawn in each case in the FIGS. 2 and 3. Clearly, the telecommunication network which extends between the subscribers can consist of a plurality of subnetworks, wherein each subnetwork can in turn consist of a plurality of exchanges. Various communication protocols or protocol families can be utilized in the subnetworks, e.g. the connection between the terminal of the A subscriber and the exchange can be based on the ISDN or QSIG protocol suite. Likewise, the terminal of the A subscriber can be an IP phone, and the transmission of voice and signaling data can take place over IP protocols.

The terminal of the A subscriber does not have to be a conventional telephone, and can also be e.g. a CTI client in the context of computer-aided telephony (“Computer Telephony Integration”, CTI).

Furthermore, the communication between the agents, i.e. between the user query unit and the directory system query unit can likewise be based on the X.500 standard or other such protocols or standards for directory systems instead of being based on the LDAP protocol. It is also possible for a plurality of user agents to access a directory system agent, particularly in the case of the arrangement which is described with reference to FIG. 3. It is likewise conceivable for a plurality of directory system agents to exist in an arrangement according to the invention. An inquiry which arrives at a directory system query unit from a user query unit is forwarded to the other directory system query units if this unit is not able to answer the inquiry itself. These transfer their results directly to the inquiring user query unit or via the original directory system query unit.

User agent as well as directory system agent and even the directory system itself can be implemented individually or in combination on the terminal. This can be effective in small networks, in which a terminal has responsibility for this extended functionality (e.g. the telephone system at the reception of an office complex).

Within the context of the fundamental idea as specified in the following claims, further embodiments can be conceived as a result of actions by a person skilled in the art, without going beyond the scope of the invention.

1.-15. (canceled)

16. A method for call forwarding after a call from a first telecommunication terminal is not accepted at a second telecommunication terminal, the method comprising:
entering a first called number associated to the second terminal at the first terminal, the number entered to establish a connection to the second terminal;
triggering a transfer of an identification inquiry message containing the first call number to an automatic telecommunication service in order to identify an alternative call number;
identifying a second call number associated to a third telecommunication terminal by a telecommunication service via an electronic directory system comprising a stored assignment specification; and
providing the second call number for establishing a connection between the first terminal and the third terminal.

17. The method according to claim 16, wherein the transfer is triggered in response to a first input of a user at the first terminal.

18. The method according to claim 17, wherein an attribute value is assigned in the directory system the for the second call number.

19. The method according to claim 18, wherein for the first call number the assignment specification includes an attribute value having the second call number.

20. The method according to claim 18, wherein the assignment specification includes an attribute value, wherein the attribute value for the first call number is the same as the attribute value for the second call assignment specification.

21. The method according to claim 16, wherein the connection setup between the first and third terminal is initiated automatically after identification of the second call number.

22. The method according to claim 16, wherein the telecommunication service transfers identification results information to the first terminal in response to the identification inquiry message, the identification result information is provided to the first terminal via a display unit or via voice.

23. The method according to claim 22, wherein the identification result information includes the second call number.

24. The method according to claim 22, wherein after providing the identification result information to the first terminal, the user provides a second input to effect the connection setup to the third terminal.

25. The method according to claim 22, wherein a central exchange includes the telecommunication service and/or the directory system.

26. The method according to claim 22, wherein the telecommunication service and/or the directory system is distributed over a plurality of central exchanges.

27. The method according to claim 22, wherein the telecommunication service and/or the directory system is implemented in the first terminal.

28. An arrangement including a plurality of telecommunication terminals, comprising:
a first terminal adapted to accept input of a user;
a directory system query unit configured for submitting a query to an electronic directory system in order to identify a second call number assigned to a first call number, the first call number previously entered at the first terminal; and
a forwarding control unit adapted to transfer the first call number to the directory system query unit after a first input of a user at the first terminal and to receive the second call number from the directory system query unit,
wherein the first terminal includes the forwarding control unit or
wherein an exchange includes the forwarding control unit.

29. The arrangement to claim 28, wherein the first terminal includes the directory system query unit, or wherein the exchange includes the directory system query unit.

30. The arrangement to claim 29, wherein after receiving the second call number, the forwarding control unit is configured for transferring a control command in order to trigger a connection setup from the first terminal to a third terminal that is associated to the second called number.

31. The arrangement to claim 30,
wherein the first terminal is configured for automatically initiating the setup of a connection to the third terminal via the second call number, without a second input from the user, or
wherein the exchange is configured for automatically initiating the setup of a connection to the third terminal via the second call number, without a second input from the user.

32. The arrangement to claim 28, wherein the first terminal includes a predefined key for accepting the first and/or a second input.

33. The arrangement to claim 28, wherein the first terminal includes a display unit with assigned control keys for navigation and selection of a menu option from a menu displayed on the display unit.

34. The arrangement to claim 28, wherein the first terminal includes a voice recognition system for recognizing a voice input of the first and/or a second input.
